(19) United States
(12) Patent Application Publication
(10) Pub. No.: US 2017/0124574 A1
(43) Pub. Date: May 4, 2017

(54) METHOD AND SYSTEM FOR IDENTIFYING SYNERGISTIC MERCHANT RELATIONSHIPS

(71) Applicant: MasterCard International Incorporated, Purchase, NY (US)

(72) Inventors: Jean-Pierre GERARD, Croton-On-Hudson, NY (US); Kenneth UNSER, Fairfield, CT (US)

(73) Assignee: MASTERCARD INTERNATIONAL INCORPORATED, Purchase, NY (US)

(21) Appl. No.: 14/926,547

(22) Filed: Oct. 29, 2015

(51) Int. Cl. G06Q 30/02; G06F 17/30

(52) U.S. Cl. CPC G06Q 30/0201; G06F 17/30867; G06F 17/3087; G06F 17/30241

(57) ABSTRACT

A method for identifying mutually beneficial merchant opportunities based on commonality in transaction data includes: storing transaction messages, each related to a payment transaction and including an account number, merchant identifier, merchant category, and location; receiving a mutually beneficial merchant request, the request including a specific merchant identifier and location; identifying a first subset of transaction messages where each includes the specific merchant identifier and location; identifying a second subset of transaction messages where each includes an account number included in at least one transaction message in the first subset and (i) a merchant category not included in the first subset and a location within a predetermined distance of the specific location, or (ii) a merchant category included in the first subset and a location outside of the predetermined distance of the specific location; and identifying a mutually beneficial merchant identifier based on a frequency in the second subset.

### FIELD

The present disclosure relates to identifying potentially mutually beneficial and possibly synergistic merchant opportunities, specifically the use of commonality in electronic transaction data to identify opportunities for merchant mutually beneficial and perhaps synergistic relationships based on the transaction data commonality.

### BACKGROUND

Merchants often use a wide variety of techniques in order to entice consumers to visit their stores. Merchants may issue coupons, publish advertisements, hold special events, reach out to individual consumers via mailers or newsletters, and other similar methods in order to inform consumers of their business, as well as to encourage consumers to visit (virtual or physically) and transact with them. However, despite the large variety of methods merchants can use to reach out to consumers, merchants are always looking for newer and more effective ways.

One method that has been utilized by merchants is the use of cooperation between two merchants. For example, a restaurant next to a movie theatre may make a deal with the movie theatre to provide a discounted meal for patrons of the theatre, as a way of encouraging people to become movie-goers and eat at that particular restaurant rather than elsewhere. Such arrangements may be beneficial to both merchants, as it may increase revenue for both due to increased business, sharing of receipts, increased consumer goodwill, etc. However, such deals are often created out of convenience and proximity, without regard for consumer behavior. In many instances, merchants that may be interested in cooperating with another merchant may lack information regarding their own consumers, let alone consumers of potential partnering merchants, and is sometimes limited to antidotal evidence such as from conversations with a subset of customers. Even in instances where the potential partnering merchant may possess information on their own consumers, such information is often disparate in that it cannot be matched, such as to determine if the two merchants have consumers in common or consumers with common interests that may be influenced by a cooperative deal.

Thus, there is a need for a technical solution to identify business and perhaps synergistic opportunities between two merchants based on commonality of consumer by a form of unique identifiers and other transaction data. By using data that is captured and utilized during the processing of transactions, overlap in consumers for two separate merchants can be identified and used in the identification of a potential beneficial or even synergistic relationship opportunity with accuracy and precision currently unavailable to merchants using traditional systems.

### SUMMARY

The present disclosure provides a description of systems and methods for identifying mutually beneficial or even synergistic merchant opportunities based on commonality in transaction data.

A method for identifying mutually beneficial merchant opportunities based on commonality in transaction data includes: storing, in a transaction database of a processing server, a plurality of transaction data entries, wherein each transaction data entry includes data related to a payment transaction including at least a primary account number, a merchant identifier, a merchant category code, and a geographic location; receiving, by a receiving device of the processing server, a data signal comprising a mutually beneficial merchant request, wherein the mutually beneficial merchant request includes at least a specific merchant identifier and a specific geographic location; executing, by a processing device of the processing server, a first query on the transaction database to identify a first subset of transaction data entries where each transaction data entry included in the first subset includes a merchant identifier corresponding to the specific merchant identifier and a geographic location corresponding to the specific geographic location; executing, by the processing device of the processing server, a second query on the transaction database to identify a second subset of transaction data entries where each transaction data entry included in the second subset includes a primary account number included in at least one transaction data entry included in the first subset of transaction data entries and (i) a merchant category code not included in each transaction data entry included in the first subset of transaction data entries and a geographic location within a predetermined distance of the specific geographic location, or (ii) a merchant category code included in each transaction data entry included in the first subset of transaction data entries and a geographic location outside of the predetermined distance of the specific geographic location; identifying, by the processing device of the processing server, a mutually beneficial merchant identifier based on a frequency of the mutually beneficial merchant identifier as the merchant identifier included in the transaction data entries of the second subset of transaction data entries; and electronically transmitting, by a transmitting device of the processing server, a data signal in response to the received data signal, the transmitted data signal comprising at least the identified mutually beneficial merchant identifier.

A system for identifying mutually beneficial merchant opportunities based on commonality in transaction data includes a transaction database, a receiving device, a processing device, and a transmitting device of a processing server. The transaction database of the processing server is configured to store a plurality of transaction data entries, wherein each transaction data entry includes data related to a payment transaction including at least a primary account number, a merchant identifier, a merchant category code, and a geographic location. The receiving device of the processing server is configured to receive a data signal comprising a mutually beneficial merchant request, wherein the mutually beneficial merchant request includes at least a specific merchant identifier and a specific geographic location. The processing device of the processing server is configured to: execute a first query on the transaction database to identify a first subset of transaction data entries where each transaction data entry included in the first subset includes a merchant identifier corresponding to the specific merchant identifier and a geographic location corresponding to the specific geographic location; execute a second query on the transaction database to identify a second subset of transaction data entries where each transaction data entry included in the second subset includes a primary account number included in at least one transaction data entry included in the first subset of transaction data entries and (i) a merchant category code not included in each transaction data entry included in the first subset of transaction data entries and a geographic location within a predetermined distance of the specific geographic location, or (ii) a merchant category code included in each transaction data entry included in the first subset of transaction data entries and a geographic location outside of the predetermined distance of the specific geographic location; and identify a mutually beneficial merchant identifier based on a frequency of the mutually beneficial merchant identifier as the merchant identifier included in the transaction data entries of the second subset of transaction data entries. The transmitting device of the processing server is configured to electronically transmit a data signal in response to the received data signal, the transmitted data signal comprising at least the identified mutually beneficial merchant identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the identification of mutually beneficial merchant opportunities in accordance with exemplary embodiments.

FIG. 2 is a block diagram illustrating the processing server of FIG. 1 for the identification of mutually beneficial merchant opportunities in accordance with exemplary embodiments.

FIG. 3 is a flow diagram illustrating the identification of mutually beneficial merchants using commonality in transaction data in accordance with exemplary embodiments.

FIG. 4 is a diagram illustrating the identification of a mutually beneficial merchant opportunity using transaction data in accordance with exemplary embodiments.

FIG. 5 is a flow diagram illustrating an exemplary method for identifying mutually beneficial merchant opportunities based on commonality in transaction data in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc. In some instances, as used herein, the term “issuer” may refer to an apparatus or device of an issuer entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Identifying Mutually Beneficial Merchant Opportunities

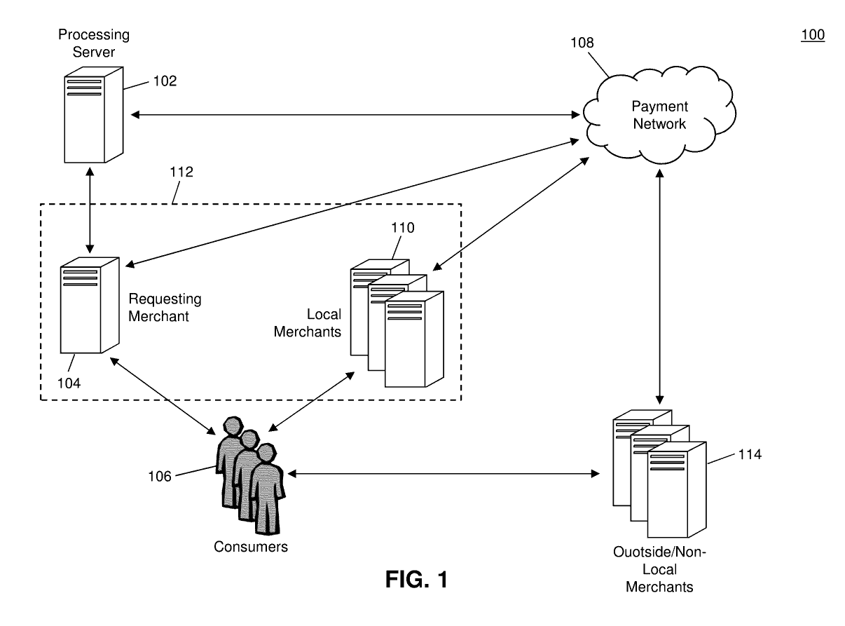

FIG. 1 illustrates a system 100 for the identification of mutually beneficial merchant opportunities using commonality in transaction data.

The system 100 may include a processing server 102. The processing server 102, discussed in more detail below, may be configured to identify mutually beneficial merchant opportunities based on commonality in transaction data for a requesting merchant 104 and other merchants. The requesting merchant 104 may be a merchant that participates in electronic payment transactions with a plurality of consumers 106. As used herein, “requesting merchant” may refer to the entity itself or the computing devices and systems associated thereto suitable for use in performing the functions discussed herein, such as point of sale computing systems and device, inventory systems and devices, communication systems and devices, etc. The requesting merchant 104 may electronically transmit a data signal to the processing server 102 via a suitable communication network, such as the Internet, a cellular communication network, a local area network, a wireless area network, a radio frequency network, etc. The data signal may be superimposed with a mutually beneficial merchant request.

The mutually beneficial merchant request may be a request to identify a mutually beneficial merchant opportunity between the requesting merchant 104 and one or more other merchants. The mutually beneficial merchant request may include at least a merchant identifier associated with the requesting merchant and a geographic location. The merchant identifier may be a unique value associated with the requesting merchant 104 suitable for use in identification of the requesting merchant 104 or data associated therewith, such as transaction data for a payment transaction involving the requesting merchant 104. The merchant identifier may be, for example, a merchant identification number, transaction account number, internet protocol address, media access control address, point of sale identifier, etc.

The processing server 102 may receive the data signal superimposed with the mutually beneficial merchant request and may parse the data signal (e.g., deconstruct into constituent data elements and values) to obtain the mutually beneficial merchant request and data included therein, including the merchant identifier and geographic location. The processing server 102 may then use the data to identify transaction data for payment transactions involving the requesting merchant 104.

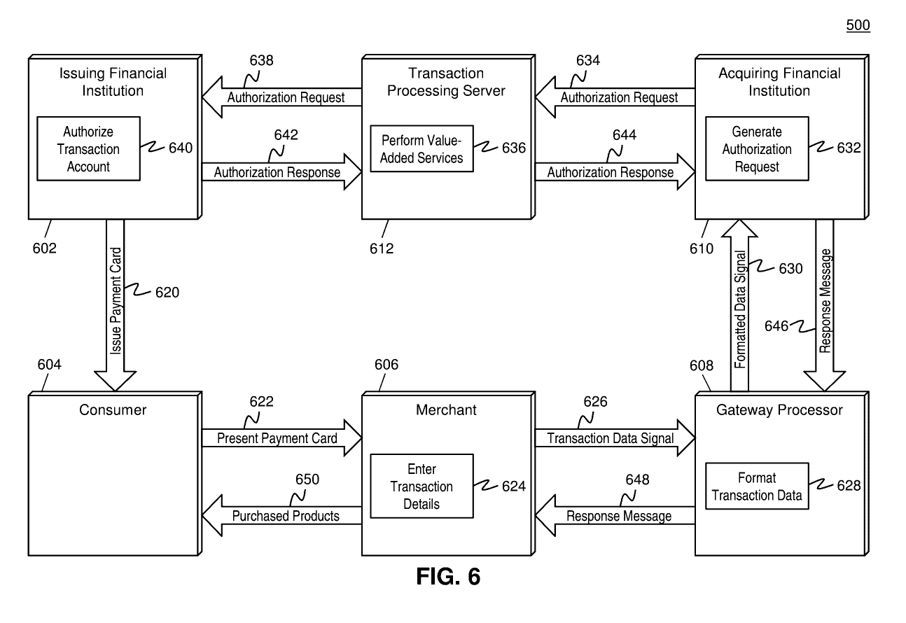

Payment transactions involving the requesting merchant 104 may be processed by a payment network 108, which may be an entity and system configured to process payment transactions using traditional methods, such as discussed in more detail below with respect to the process 600 illustrated in FIG. 6. The payment network 108 may be configured to process payment transactions involving the requesting merchant 104 and consumers 106 as well as payment transactions involving the consumers 106 and one or more local merchants 110. Local merchants 110 may be merchants other than the requesting merchant 104 that are located in a geographic area 112 that includes the requesting merchant 104.

The geographic area 112 may be based on a plurality of different suitable criteria. For example, in one embodiment, the geographic area 112 may be a predetermined distance around the geographic location of the requesting merchant 104 (e.g., parsed from the mutually beneficial merchant request). In another embodiment, the geographic area may be a municipally-defined area, such as city, county, zip code, postal code, neighborhood, etc. In some instances, the predetermined distance or other criteria used to define the geographic area 112 may be based on the requesting merchant 104. For instance, the requesting merchant 104 may specify (e.g., in the mutually beneficial merchant request) the predetermined distance, the predetermined distance may be based on an industry of the requesting merchant 104, an industry of mutually beneficial merchants requested by the requesting merchant 104, etc.

The payment network 108 may also process payment transactions involving the consumers 106 and outside merchants 114. Outside merchants 114 may be merchants located outside of the geographic area 112. In some instances, outside merchants 114 may be located in a second geographic area, such as one that may be specified by the requesting merchant 104. For example, the requesting merchant 104 may request identification of a mutually beneficial merchant located in the local geographic area 112, or in a specific external geographic area that includes the outside merchants 114 where the requesting merchant 104 may be interested in a cooperative relationship, such as in an area where the requesting merchant 104 may want to expand, a regular travel destination for consumers 106, etc.

As part of the processing of payment transactions, the payment network 108 may capture transaction data for each of the payment transactions involving the consumers 106 and the requesting merchant 104, local merchants 110, and outside merchants 114. The transaction data may include a primary account number, a merchant identifier, a merchant category code, and a geographic location for each payment transaction. The primary account number may be an account number associated with a transaction account used to fund the respective payment transaction. The merchant identifier may be associated with the merchant involved in the respective payment transaction, such as the requesting merchant 104, a local merchant 110, or an outside merchant 114. The merchant category code may be a value associated with an industry or other categorization of the merchant involved in the respective payment transaction. In some instances, values used as merchant category codes may be specified by a standard, such as set forth by the payment network 108 or other entity. The geographic location may be a location associated with the payment transaction, such as location of the merchant involved in the respective payment transaction. The geographic location may be represented using any suitable format, such as latitude and longitude, street address, zip code, etc.

The payment network 108 may provide transaction data for the payment transactions to the processing server 102. In some embodiments, the payment network 108 may electronically transmit the transaction data as superimposed on data signals electronically transmitted to the processing server 102 via the payment rails or an alternative, suitable communication network. In other embodiments, the payment network 108 may electronically transmit transaction messages to the processing server 102 via the payment rails. Transaction messages may be data messages specially formatted pursuant to one or more standards governing the exchange of financial transaction messages, such as the International Organization of Standardization's ISO 8583 standard. Transaction messages, as discussed in more detail below with respect to the process 600 illustrated in FIG. 6, may be used to electronically exchange transaction data for payment transactions processed via a payment network 108. Transaction messages may include a plurality of data elements configured to store data as set forth in the associated standard. For example, each transaction message may include data elements configured to store the primary account number, merchant identifier, merchant category code, and geographic location associated with the respective payment transaction.

In some embodiments, the processing server 102 may be a part of the payment network 108. In such embodiments, the processing server 102 may receive the transaction data via internal communication from the payment network 108. In some cases, the processing server 102 may be configured to process payment transactions. In such cases, the processing server 102 may capture and store the transaction data or transaction messages that store the transaction data as part of the processing of payment transactions.

The processing server 102 may be configured to identify transaction data for payment transactions involving the requesting merchant 104 using the data parsed from the received mutually beneficial merchant request. For example, the processing server 102 may identify transaction data for payment transactions where the merchant identifier and geographic location correspond to the merchant identifier and geographic location received and parsed from the mutually beneficial merchant request provided by the requesting merchant 104. The processing server 102 may then identify the consumers 106 involved in the payment transactions involving the requesting merchant 104, such as by identifying the primary account numbers included in the transaction data identified for each of the payment transactions.

The processing server 102 may then identify transaction data for payment transactions involving the consumers 106 and the local merchants 110 and/or outside merchants 114. In some instances, the mutually beneficial merchant request may specific if local merchants 110 and/or outside merchants 114 are to be identified for a mutually beneficial relationship with the requesting merchant 104. The transaction data identified by the processing server 102 for local merchants 110 may include a primary account number identified from the transaction data involving the requesting merchant 104, as well as a geographic location included inside the geographic area 112 (e.g., within a predetermined distance of the geographic location parsed from the mutually beneficial merchant request). In some embodiments, the processing server 102 may identify transaction data for payment transactions involving local merchants 110 where the merchant category code is different from a merchant category code associated with the requesting merchant 104 (e.g., as included in the mutually beneficial merchant request or identified from the transaction data for payment transactions involving the requesting merchant 104). In such an embodiment, the local merchants 110 identified for a mutually beneficial merchant relationship with the requesting merchant 104 may be merchants in a different industry, such as to prevent competition with the requesting merchant 104.

Transaction data identified by the processing server 102 for payment transactions involving the outside merchants 114 and consumers 106 may include a primary account number identified from the transaction data involving the requesting merchant 104, as well as a geographic location that is outside the geographic area 112 and/or in a second geographic area as may be specified by the requesting merchant 104 in the mutually beneficial merchant request. In some embodiments, the processing server 102 may identify transaction data for payment transactions involving the outside merchants 114 where the merchant category code is the same as the merchant category code associated with the requesting merchant 104. In such an embodiment, the outside merchants 114 identified for a mutually beneficial merchant relationship with the requesting merchant 104 may be in the same industry, but in a different geographic location as to not be in competition with the requesting merchant 104. For instance, the requesting merchant 104 and outside merchants 114 may be both be restaurants, such that a consumer 106 may be encouraged to visit a mutually beneficial outside/non-local merchant 114 when traveling if they like the requesting merchant 104.

Once the transaction data has been identified, the processing server 102 may identify a mutually beneficial merchant. The mutually beneficial merchant may be a local merchant 110 or outside merchant 114 identified based on a frequency of the associated merchant identifier in the identified transaction data. In some instances, the processing server 102 may identify the merchant identifier that is included in the greatest number of payment transactions identified for local merchants 110 and/or outside merchants 114, which may indicate the most common merchant that customers of the requesting merchant 104 transact with. In other instances, the processing server 102 may identify a merchant identifier for any merchant that is included in a predetermined number of payment transactions. The predetermined number may be set, for example, by the processing server 102 or requesting merchant 104 (e.g., in the mutually beneficial merchant request). For example, the processing server 102 may identify any merchant that at least five consumers 106 of the requesting merchant 104 have also visited.

The processing server 102 may then provide the merchant identifier associated with the identified mutually beneficial merchant(s) to the requesting merchant 104, such as via superimposition on a data signal electronically transmitted by the processing server 102 to the requesting merchant 104 via a suitable communication network in response to the mutually beneficial merchant request. In some instances, the processing server 102 may provide additional information associated with the mutually beneficial merchant, such as name, geographic location, etc. The processing server 102 may also provide data (e.g., metrics, statistics, etc.) regarding the mutually beneficial merchant, as may be determined from the transaction data for payment transactions involving the mutually beneficial merchant. In some cases, the processing server 102 may also provide information to the mutually beneficial merchant, such as via electronic transmission of a separate data signal to the mutually beneficial merchant.

The methods and systems discussed herein enable the processing server 102 to identify a mutually beneficial merchant opportunity for a requesting merchant 104 as determined from stored data sets consisting of transaction data for electronically processed payment transactions involving the requesting merchant 104. By using transaction data that is captured via transaction processing, the processing server 102 can utilize information not accessible to requesting merchants 104 and can capture information for a plurality of different merchants, to better identify mutually beneficial opportunities, including with merchants the requesting merchant 104 may not typically consider. In addition, using the transaction data can result in the identification of a mutually beneficial merchant where there is concrete evidence of overlap in consumers. As a result, the processing server 102 provides a technical advantage by capturing data unavailable to merchants and performing analysis on the data to identify a mutually beneficial opportunity unique to a particular requesting merchant 104.

### Processing Server

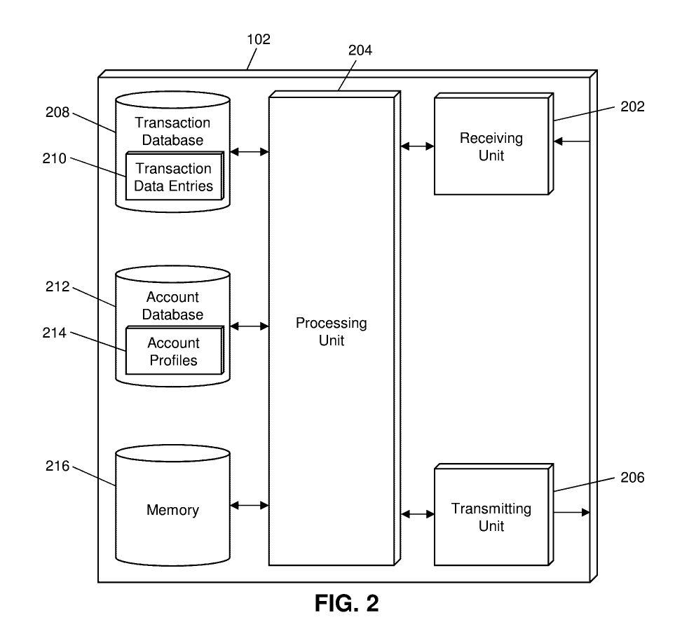

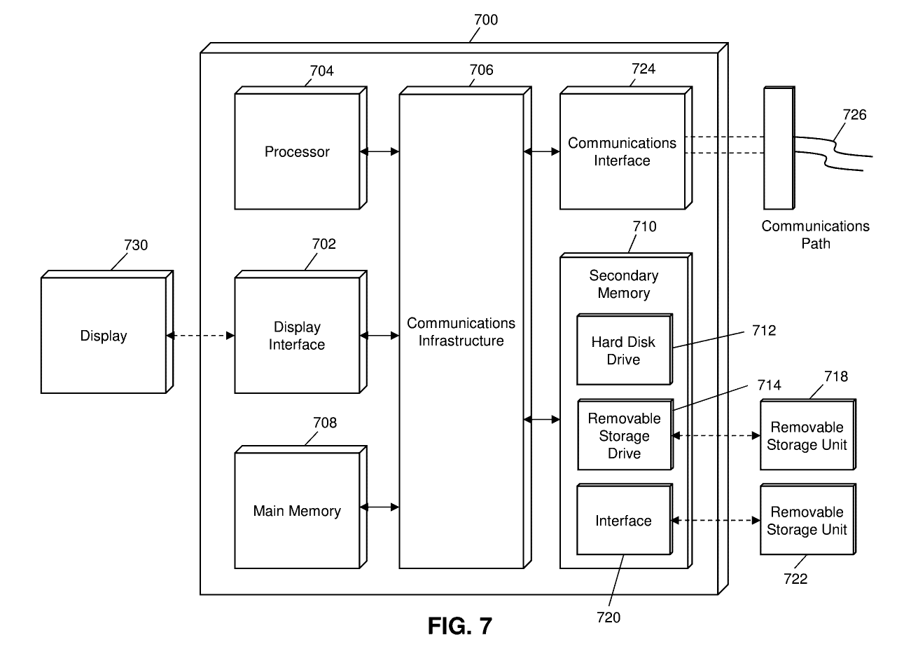

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 108 for the transmission of transaction messages that include sensitive financial data and information. In some instances, the receiving unit 202 may also be configured to receive data from requesting merchants 104, the payment network 108, local merchants 110, outside merchants 114, and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon. For example, the receiving unit 202 may include a parser program configured to receive and transform the received data signal into usable input for the functions performed by the processing unit to carry out the methods and systems described herein.

The receiving unit 202 may be configured to receive a data signal electronically transmitted by the requesting merchant 104 that is superimposed with a mutually beneficial merchant request. The mutually beneficial merchant request, once parsed from the data signal by the receiving unit 202 or another module or unit of the processing server 102, may include a merchant identifier and geographic location associated with the requesting merchant 104. The receiving unit 202 may also be configured to receive transaction data electronically transmitted by the payment network 108, such as may be superimposed on data signals and/or included in specially formatted transaction messages.

The processing server 102 may include a transaction database 208. The transaction database 208 may be configured to store a plurality of transaction data entries 210 using a suitable data storage format and schema. Each transaction data entry 210 may be a standardized data set configured to store data related to a payment transaction, including at least a primary account number associated with a transaction account used to fund the payment transaction, a merchant identifier and merchant category code associated with a merchant involved in the payment transaction, and a geographic location associated with the payment transaction. In some instances, each transaction data entry 210 may be, or may store, a transaction message formatted pursuant to one or more standards, such as the ISO 8583 standard, that includes a plurality of data elements configured to store the primary account number, merchant identifier, merchant category code, geographic location, and additional transaction data. Additional transaction data may include, for example, transaction amount, transaction time, transaction data, acquiring financial institution data, issuing financial institution data, consumer data, merchant data, point of sale data, product data, offer data, reward data, loyalty data, etc. In some instances, the additional transaction data may be used in the processes discussed herein, such as where transaction data identified for use in identifying mutually beneficial merchant relationships may be identified using a transaction date, such as for identifying transactions occurring within a year of the mutually beneficial merchant request.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. As used herein, the term “module” may be software or hardware particularly programmed to receive an input, perform one or more processes using the input, and provide an output. The input, output, and processes performed by various modules will be apparent to one skilled in the art based upon the present disclosure.

For example, the processing unit 204 may include a querying module configured to query databases included in the processing server 102 to identify information stored therein. The querying module may be configured to receive a query string and/or data for inclusion therein, may execute a query based thereon on a database, and may output one or more data sets or values identified as a result of execution of the query. The querying module may be configured to execute queries on the transaction database 208 to identify transaction data entries 210. For instance, the querying module may identify transaction data entries 210 involving a requesting merchant 104, by executing a query configured to identify transaction data entries 210 that include the merchant identifier and geographic location associated with the requesting merchant 104, such as may be parsed from the received mutually beneficial merchant request. The querying module may also identify transaction data entries 210 involving a group of consumers 106, by executing a query to identify transaction data entries 210 that include primary account numbers associated with the group of consumers 106, such as identified from transaction data entries 210 identified by the querying module that involve the requesting merchant 104.

The processing unit 204 may also include a data identification module. The data identification module may be configured to identify one or more data values from sets of data, such as sets of data identified by the querying module. The data identification module may receive one or more data sets, may perform analysis thereon to identify one or more specific data values, and may output the identified data values. For example, the data identification module may be configured to identify a group of primary account numbers from a set of transaction data entries 210 identified by the querying module that are related to payment transactions involving the requesting merchant 104.

The processing unit 204 may further include a mutually beneficial analysis module. The mutually beneficial analysis module may be configured to identify a mutually beneficial merchant identifier from a set of transaction data entries 210 based on commonality in the transaction data included therein. The mutually beneficial analysis module may receive data sets, may perform analysis on the data included therein, and may output one or more mutually beneficial merchant identifiers and any additional data. The mutually beneficial analysis module may, for example, receive sets of transaction data entries 210 identified by the querying module that correspond to payment transactions involving local merchants 110 and/or outside merchants 114 and consumers 106. The mutually beneficial analysis module may identify one or more merchant identifiers included in the transaction data entries 210 based on frequency of the merchant identifier in the transaction data entries 210. In some embodiments, the mutually beneficial analysis module may identify a merchant identifier that has a greater frequency in the transaction data entries 210 than any other merchant identifier. In other embodiments, the mutually beneficial analysis module may identify any merchant identifier that has a frequency above a predetermined threshold, such as may be parsed from a received mutually beneficial merchant request or stored in a database of the processing server 102.

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 108 for the transmission of transaction messages that include sensitive financial data and information, such as identified payment credentials. In some instances, the transmitting unit 206 may be configured to transmit data to requesting merchants 104, payment networks 108, local merchants 110, outside merchants 114, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet.

The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to electronically transmit data signals to the requesting merchant 104 via a suitable communication network that are superimposed with mutually beneficial merchant identifiers. In some instances, the data signals may also be superimposed with additional data associated with a merchant corresponding to a mutually beneficial merchant identifier, such as a merchant category code and/or geolocation included in a transaction data including the mutually beneficial merchant identifier, or additional data. For example, the processing server 102 may also include an account database 212 configured to store a plurality of account profiles 214 using a suitable data storage format and schema. Each account profile 214 may include a standardized data set configured to store data associated with a merchant. The account profile 214 may include, for example, the associated merchant identifier and any additional data, such as a merchant category code, geographic location, transaction account number, name, description, industry, financial data, location data, franchise data, etc. In such instances, data signals superimposed with mutually beneficial merchant identifiers transmitted to requesting merchants 104 by the transmitting unit 206 may also be superimposed with additional data associated with the related merchant, such as may be stored in the corresponding account profile 214 (e.g., identified via execution of a query by the querying module using the mutually beneficial merchant identifier). In some cases, the additional data superimposed on the data signal may be specified in the mutually beneficial merchant request.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for modules and application programs of the processing unit 204, and other data that may be suitable for use by the processing server 102 in the performance of the functions disclosed herein as will be apparent to persons having skill in the relevant art.

### Process for Identifying a Mutually Beneficial Merchant Opportunity

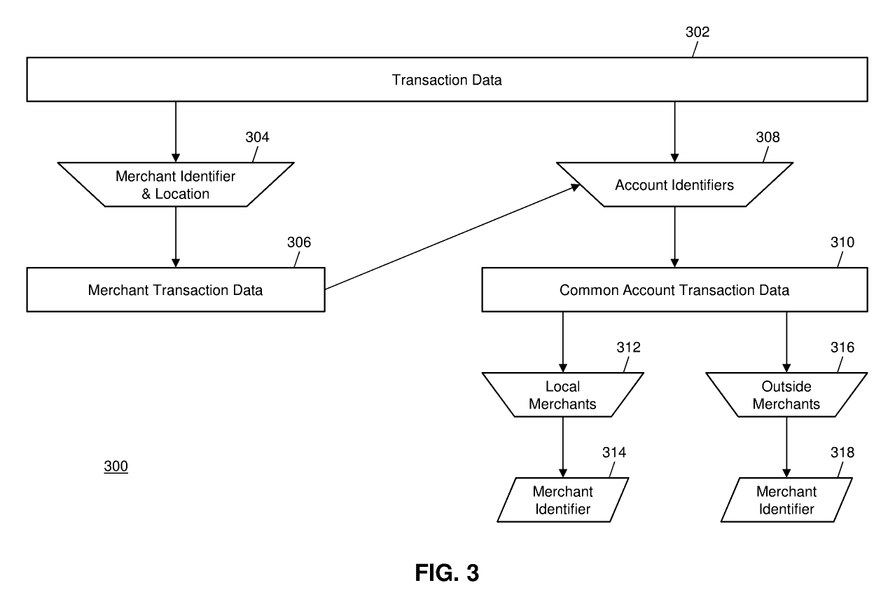

FIG. 3 illustrates a process 300 for the identification of a mutually beneficial merchant opportunity between two merchants based on commonality in transaction data.

In step 302, the processing server 102 may store transaction data, which may be stored as transaction data entries 210 in the transaction database 208. Each transaction data entry 210 may be related to an electronic payment transaction processed by the payment network 108 and include a primary account number, merchant identifier, merchant category code, and a geographic location. In step 304, a merchant identifier and geographic location may be used to identify a subset of the transaction data 302. The querying module of the processing unit 204 of the processing server 102 may execute a query on the transaction database 208 to identify transaction data entries 210 that include the merchant identifier and geographic location used in step 304. The merchant identifier and geographic location may be parsed from a mutually beneficial merchant request received by the receiving unit 202 of the processing server 102 from the requesting merchant 104.

The request of the query on the transaction database 208 of the querying module may be the merchant transaction data 306. The merchant transaction data 306 may consist of transaction data entries 210 associated with payment transactions involving the requesting merchant 104. In step 308, the data identification module of the processing unit 204 of the processing server 102 may identify a plurality of account identifiers from the merchant transaction data 306. The account identifiers may be primary account numbers included in the transaction data entries 210 comprising the merchant transaction data 306. The querying module of the processing unit 204 may use the account identifiers in the execution of a query on the transaction database 208 to identify common account transaction data 310.

The common account transaction data 310 may include transaction data entries 210 from the transaction database 208 that include the primary account numbers identified from the merchant transaction data 306. The transaction data entries 210 may thus correspond to payment transactions involving local merchants 110 and outside merchants 114 and the consumers 106 that were involved in the payment transactions of the requesting merchant 104.

In step 312, the data identification module and/or mutually beneficial analysis module of the processing unit 204 may identify transaction data entries 210 in the common account transaction data 310 that correspond to payment transactions involving local merchants 110. The transaction data entries 210 that correspond to payment transactions involving the local merchants 110 may include a geographic location that is included in the geographic area 112, which may be within a predetermined distance of the geographic location included in the mutually beneficial merchant request and used in step 304. In some instances, transaction data entries 210 that corresponding to payment transactions involving local merchants 110 may also include a merchant category code that is different from a merchant category code associated with the requesting merchant 104, such as may be included in the mutually beneficial merchant request and/or identified form the merchant transaction data 306. In step 314, the mutually beneficial analysis module may identify a merchant identifier associated with a local merchant 110 based on a frequency of the merchant identifier in the local transaction data. The merchant identifier, and any other additional data associated with the corresponding local merchant 110, may be superimposed on a data signal electronically transmitted by the transmitting unit 206 of the processing server 102 to the requesting merchant 104. The requesting merchant 104 may then approach the corresponding local merchant 110 for a mutually beneficial relationship.

In step 316, the data identification module and/or mutually beneficial analysis module of the processing unit 204 may identify transaction data entries 210 in the common account transaction data 310 that correspond to payment transactions involving outside merchants 114. The transaction data entries 210 that correspond to payment transactions involving the outside merchants 114 may include a geographic location that is outside of the geographic area 112, which may be outside of a predetermined distance of the geographic location included in the mutually beneficial merchant request and used in step 304. In some instances, transaction data entries 210 that corresponding to payment transactions involving outside merchants 114 may also include a merchant category code that is the same as the merchant category code associated with the requesting merchant 104, such as may be included in the mutually beneficial merchant request and/or identified form the merchant transaction data 306. In step 318, the mutually beneficial analysis module may identify a merchant identifier associated with an outside merchant 114 based on a frequency of the merchant identifier in the outside transaction data. The merchant identifier, and any other additional data associated with the corresponding outside merchant 114, may be superimposed on a data signal electronically transmitted by the transmitting unit 206 of the processing server 102 to the requesting merchant 104. The requesting merchant 104 may then approach the corresponding outside merchant 114 for a mutually beneficial relationship.

In some embodiments, the mutually beneficial analysis module may be configured to identify only a single merchant identifier. In such instances, the merchant identifier may be identified from the local merchants 110 and outside merchants 114, such as by identifying a more suitable (e.g., more frequent, more suited to requesting merchant 104 criteria or preferences, etc.) merchant identifier from the merchant identifiers produced in steps 314 and 318. For example, the mutually beneficial analysis module may identify which of the merchant identifiers has a higher frequency in terms of number of transactions or in terms of relative frequency, such as based on a percentage of the respective merchant identifier in local transactions or outside transactions, as applicable.

### Process for Identifying a Mutually Beneficial Merchant Based on Transaction Commonality

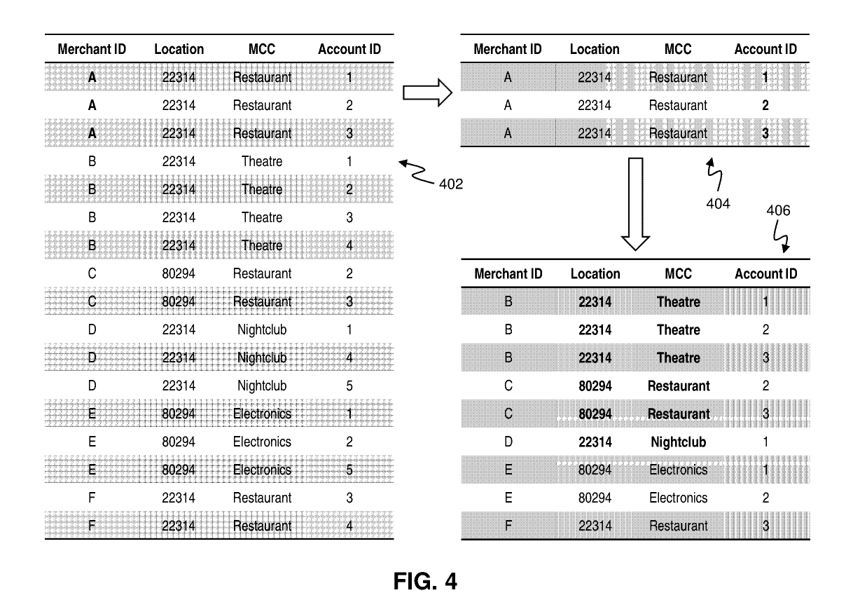

FIG. 4 illustrates the identification of one or more mutually beneficial merchant opportunities for a requesting merchant 104 based on commonality of transaction data for the requesting merchant 104 and potential mutually beneficial merchants.

Table 402 illustrated in FIG. 4 includes a plurality of transaction data entries 210, such as stored in the transaction database 208. Each transaction data entry 210 may include at least a merchant identifier, geographic location, merchant category code, and account identifier. As illustrated in FIG. 4, the geographic location included in each transaction data entry 210 in the table 402 may be represented by a zip code, which may be considered to be a geographic area 112 such that a merchant included in the geographic area 112 is considered a local merchant 110 with respect to the requesting merchant 104.

Table 402 includes a plurality of transaction data entries 210 for each of six different merchants. Merchant A (e.g., the merchant associated with the merchant identifier “A”), as well as merchants D and E, are each involved in three payment transactions, merchant B is involved in four payment transactions, and merchants C and F are involved in two payment transactions. Merchant A may be the requesting merchant 104, and may be included in the geographic area 112 having the zip code 22314. Merchants B, D, and F may thus be local merchants 110, while merchants C and E may be outside merchants 114.

Table 404 illustrates transaction data entries 210 identified by the querying module of the processing unit 204 of the processing server 102 identified as involving the requesting merchant 104, merchant A. The data identification module of the processing unit 204 of the processing server 102 may then identify the account identifiers included in the transaction data entries 210 of table 404 as corresponding to consumers 106 involved in payment transactions with the requesting merchant 104, merchant A. As illustrated in FIG. 4, the data identification module may identify accounts 1, 2, and 3 as being involved in payment transactions with merchant A.

Table 406 illustrates transaction data entries identified by the querying module as involving the accounts 1, 2, and 3 and merchants other than the requesting merchant A. As illustrated in FIG. 4, the accounts 1, 2, and 3 may be involved in payment transactions with both local merchants 110, merchants B, D, and F, as well as outside merchants 114, merchants C, and E. The mutually beneficial analysis module may then identify merchant identifiers associated with local merchants 110 and/or outside merchants 114 for mutually beneficial opportunities with the requesting merchant 104 based on their frequency in the transaction data entries in the table 406.

In the example illustrated in FIG. 4, the mutually beneficial analysis module may identify merchants B, C, and D for mutually beneficial opportunities. Merchants B and D are local merchants 110 that have different merchant category codes from the requesting merchant 104, merchant A. Merchant C is an outside merchant 114 that has the same merchant category code as the requesting merchant 104, merchant A. In some instances, the mutually beneficial analysis module may filter the identified merchants. For instance, in the example illustrated in FIG. 4, the mutually beneficial analysis module may identify only merchant B as having the highest frequency of transactions, may identify merchants B and C has having the highest frequency of local and outside transactions, respectively, may identify merchants B, C, and D as each correspond to a different market based on the geographic locations and merchant category codes, etc. In the example illustrated in FIG. 4, the mutually beneficial analysis module may not identify merchants E and F as being mutually beneficial merchants due to merchant E being in outside of the geographic area 112 and having a different merchant category code and merchant F being in the geographic area 112 and having the same merchant category code.

### Exemplary Method for Identifying Mutually Beneficial Merchant Opportunities Based on Commonality in Transaction Data

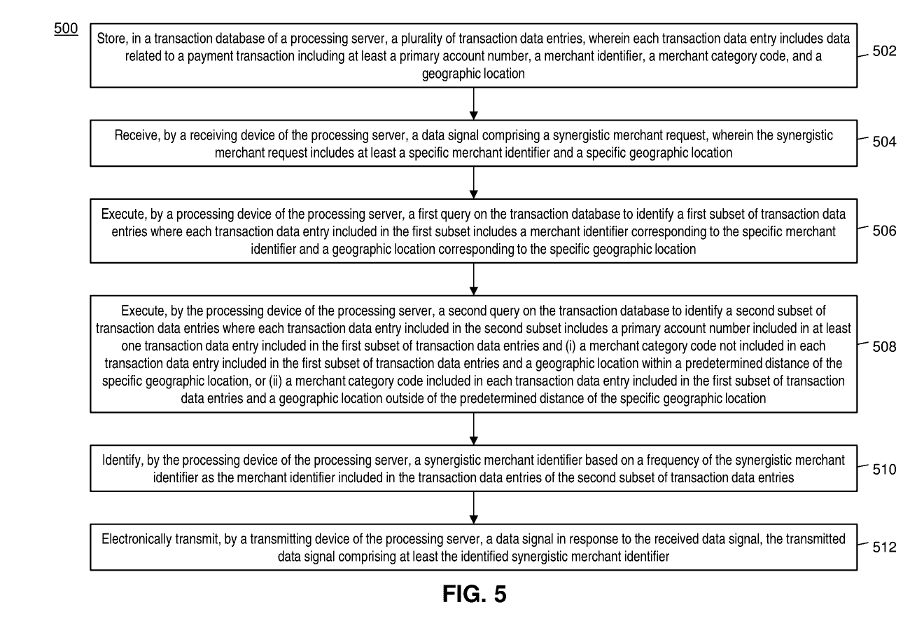

FIG. 5 illustrates a method 500 for the identification of mutually beneficial merchant opportunities for a requesting merchant based on commonality in transaction data for the requesting merchant with transaction data for potential mutually beneficial merchants.

In step 502, a plurality of transaction data entries (e.g., transaction data entries 210) may be stored in a transaction database (e.g., the transaction database 208) of a processing server (e.g., the processing server 102), wherein each transaction data entry includes data related to a payment transaction including at least a primary account number, a merchant identifier, a merchant category code, and a geographic location. In step 504, a data signal comprising a mutually beneficial merchant request may be received by a receiving device (e.g., the receiving unit 202) of the processing server, wherein the mutually beneficial merchant request includes at least a specific merchant identifier and a specific geographic location.

In step 506, a first query may be executed by a processing device (e.g., the processing device 204) of the processing server on the transaction database to identify a first subset of transaction data entries where each transaction data entry included in the first subset includes a merchant identifier corresponding to the specific merchant identifier and a geographic location corresponding to the specific geographic location. In step 508, a second query may be executed on the transaction database by the processing device of the processing server to identify a second subset of transaction data entries where each transaction data entry included in the second subset includes a primary account number included in at least one transaction data entry included in the first subset of transaction data entries and (i) a merchant category code not included in each transaction data entry included in the first subset of transaction data entries and a geographic location within a predetermined distance of the specific geographic location, or (ii) a merchant category code included in each transaction data entry included in the first subset of transaction data entries and a geographic location outside of the predetermined distance of the specific geographic location.

In step 510, a mutually beneficial merchant identifier may be identified by the processing device of the processing server based on a frequency of the mutually beneficial merchant identifier as the merchant identifier included in the transaction data entries of the second subset of transaction data entries. In step 512, a data signal may be electronically transmitted by a transmitting device (e.g., the transmitting unit 206) of the processing server in response to the received data signal, the transmitted data signal comprising at least the identified mutually beneficial merchant identifier.

In one embodiment, the transmitting data signal may further comprise at least one of: a merchant category code and geographic location included in each transaction data entry of the second subset of transaction data entries that includes the mutually beneficial merchant identifier. In some embodiments, the frequency of the mutually beneficial merchant identifier as the merchant identifier included in the transaction data entries of the second subset of transaction data entries may be greater than a frequency of any other merchant identifier included in the transaction data entries of the second subset of transaction data entries.

In one embodiment, each transaction data entry of the transaction database may include a transaction message formatted based on one or more standards, and wherein the primary account number may be included in a first data element, the merchant identifier may be included in a second data element, the merchant category code may be included in a third data element, and the geographic location may be included in a fourth data element of the respective transaction message. In a further embodiment, the one or more standards may include the ISO 8583 standard.

In some embodiments, wherein the predetermined distance may be based on the merchant category code included in each transaction data entry of the first subset of transaction data entries. In one embodiment, the predetermined distance may be included in the mutually beneficial merchant request. In some embodiments, the mutually beneficial merchant request may further include one or more desired merchant category codes, and the mutually beneficial merchant identifier may be further based on inclusion of the one or more desired merchant category codes in each transaction data entry of the second subset of transaction data entries that includes the mutually beneficial merchant identifier.

In one embodiment, the mutually beneficial merchant request may further include a geographic request or category request where (i) if the mutually beneficial merchant request includes a geographic request, each transaction data entry of the second subset of transaction data entries includes a merchant category code not included in each transaction data entry included in the first subset of transaction data entries and a geographic location within the predetermined distance of the specific geographic location, and (ii) if the mutually beneficial merchant request includes a category request, each transaction data entry of the second subset of transaction data entries includes a merchant category code included in each transaction data entry included in the first subset of transaction data entries and a geographic location outside of the predetermined distance of the specific geographic location.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the consumers 106, requesting merchant 104, local merchants 110, outside merchants 114, payment network 108, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644.

The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724.

The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for identifying mutually beneficial merchant opportunities based on commonality in transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying mutually beneficial merchant opportunities based on commonality in transaction data, comprising:
storing, in a transaction database of a processing server, a plurality of transaction data entries, wherein each transaction data entry includes data related to a payment transaction including at least a primary account number, a merchant identifier, a merchant category code, and a geographic location;
receiving, by a receiving device of the processing server, a data signal comprising a mutually beneficial merchant request, wherein the mutually beneficial merchant request includes at least a specific merchant identifier and a specific geographic location;
executing, by a processing device of the processing server, a first query on the transaction database to identify a first subset of transaction data entries where each transaction data entry included in the first subset includes a merchant identifier corresponding to the specific merchant identifier and a geographic location corresponding to the specific geographic location;
executing, by the processing device of the processing server, a second query on the transaction database to identify a second subset of transaction data entries where each transaction data entry included in the second subset includes a primary account number included in at least one transaction data entry included in the first subset of transaction data entries and (i) a merchant category code not included in each transaction data entry included in the first subset of transaction data entries and a geographic location within a predetermined distance of the specific geographic location, or (ii) a merchant category code included in each transaction data entry included in the first subset of transaction data entries and a geographic location outside of the predetermined distance of the specific geographic location;
identifying, by the processing device of the processing server, a mutually beneficial merchant identifier based on a frequency of the mutually beneficial merchant identifier as the merchant identifier included in the transaction data entries of the second subset of transaction data entries; and
electronically transmitting, by a transmitting device of the processing server, a data signal in response to the received data signal, the transmitted data signal comprising at least the identified mutually beneficial merchant identifier.

2. The method of claim 1, wherein the transmitted data signal further comprises at least one of: a merchant category code and geographic location included in each transaction data entry of the second subset of transaction data entries that includes the mutually beneficial merchant identifier.

3. The method of claim 1, wherein the frequency of the mutually beneficial merchant identifier as the merchant identifier included in the transaction data entries of the second subset of transaction data entries is greater than a frequency of any other merchant identifier included in the transaction data entries of the second subset of transaction data entries.

4. The method of claim 1, wherein each transaction data entry of the transaction database includes a transaction message formatted based on one or more standards, and wherein the primary account number is included in a first data element, the merchant identifier is included in a second data element, the merchant category code is included in a third data element, and the geographic location is included in a fourth data element of the respective transaction message.

5. The method of claim 4, wherein the one or more standards includes the ISO 8583 standard.

6. The method of claim 1, wherein the predetermined distance is based on the merchant category code included in each transaction data entry of the first subset of transaction data entries.

7. The method of claim 1, wherein the predetermined distance is included in the mutually beneficial merchant request.

8. The method of claim 1, wherein
the mutually beneficial merchant request further includes one or more desired merchant category codes, and
the mutually beneficial merchant identifier is further based on inclusion of the one or more desired merchant category codes in each transaction data entry of the second subset of transaction data entries that includes the mutually beneficial merchant identifier.

9. The method of claim 1, wherein the mutually beneficial merchant request further includes a geographic request or category request where (i) if the mutually beneficial merchant request includes a geographic request, each transaction data entry of the second subset of transaction data entries includes a merchant category code not included in each transaction data entry included in the first subset of transaction data entries and a geographic location within the predetermined distance of the specific geographic location, and (ii) if the mutually beneficial merchant request includes a category request, each transaction data entry of the second subset of transaction data entries includes a merchant category code included in each transaction data entry included in the first subset of transaction data entries and a geographic location outside of the predetermined distance of the specific geographic location.

10. The method of claim 1, wherein
the mutually beneficial merchant request further includes a frequency threshold, and
the frequency of the mutually beneficial merchant identifier as the merchant identifier included in the transaction data entries of the second subset of transaction data entries exceeds the frequency threshold.

11. A system for identifying mutually beneficial merchant opportunities based on commonality in transaction data, comprising:
a transaction database of a processing server configured to store a plurality of transaction data entries, wherein each transaction data entry includes data related to a payment transaction including at least a primary account number, a merchant identifier, a merchant category code, and a geographic location;
a receiving device of the processing server configured to receive a data signal comprising a mutually beneficial merchant request, wherein the mutually beneficial merchant request includes at least a specific merchant identifier and a specific geographic location;
a processing device of the processing server configured to
execute a first query on the transaction database to identify a first subset of transaction data entries where each transaction data entry included in the first subset includes a merchant identifier corresponding to the specific merchant identifier and a geographic location corresponding to the specific geographic location,
execute a second query on the transaction database to identify a second subset of transaction data entries where each transaction data entry included in the second subset includes a primary account number included in at least one transaction data entry included in the first subset of transaction data entries and (i) a merchant category code not included in each transaction data entry included in the first subset of transaction data entries and a geographic location within a predetermined distance of the specific geographic location, or (ii) a merchant category code included in each transaction data entry included in the first subset of transaction data entries and a geographic location outside of the predetermined distance of the specific geographic location, and
identify a mutually beneficial merchant identifier based on a frequency of the mutually beneficial merchant identifier as the merchant identifier included in the transaction data entries of the second subset of transaction data entries; and
a transmitting device of the processing server configured to electronically transmit a data signal in response to the received data signal, the transmitted data signal comprising at least the identified mutually beneficial merchant identifier.

12. The system of claim 11, wherein the transmitted data signal further comprises at least one of: a merchant category code and geographic location included in each transaction data entry of the second subset of transaction data entries that includes the mutually beneficial merchant identifier.

13. The system of claim 11, wherein the frequency of the mutually beneficial merchant identifier as the merchant identifier included in the transaction data entries of the second subset of transaction data entries is greater than a frequency of any other merchant identifier included in the transaction data entries of the second subset of transaction data entries.

14. The system of claim 11, wherein each transaction data entry of the transaction database includes a transaction message formatted based on one or more standards, and wherein the primary account number is included in a first data element, the merchant identifier is included in a second data element, the merchant category code is included in a third data element, and the geographic location is included in a fourth data element of the respective transaction message.

15. The system of claim 14, wherein the one or more standards includes the ISO 8583 standard.

16. The system of claim 11, wherein the predetermined distance is based on the merchant category code included in each transaction data entry of the first subset of transaction data entries.

17. The system of claim 11, wherein the predetermined distance is included in the mutually beneficial merchant request.

18. The system of claim 11, wherein
the mutually beneficial merchant request further includes one or more desired merchant category codes, and
the mutually beneficial merchant identifier is further based on inclusion of the one or more desired merchant category codes in each transaction data entry of the second subset of transaction data entries that includes the mutually beneficial merchant identifier.

19. The system of claim 11, wherein the mutually beneficial merchant request further includes a geographic request or category request where (i) if the mutually beneficial merchant request includes a geographic request, each transaction data entry of the second subset of transaction data entries includes a merchant category code not included in each transaction data entry included in the first subset of transaction data entries and a geographic location within the predetermined distance of the specific geographic location, and (ii) if the mutually beneficial merchant request includes a category request, each transaction data entry of the second subset of transaction data entries includes a merchant category code included in each transaction data entry included in the first subset of transaction data entries and a geographic location outside of the predetermined distance of the specific geographic location.

20. The system of claim 11, wherein
the mutually beneficial merchant request further includes a frequency threshold, and
the frequency of the mutually beneficial merchant identifier as the merchant identifier included in the transaction data entries of the second subset of transaction data entries exceeds the frequency threshold.
